(19) United States
(12) Patent Application Publication
(10) Pub. No.: US 2010/0021164 A1
(43) Pub. Date: Jan. 28, 2010

(54) WDM PON RF/VIDEO BROADCAST OVERLAY

(75) Inventors: Tom LUK, Ottawa (CA); James GOODCHILD, Kanata (CA); Giovanni MANTO, Stittsville (CA); Richard HABEL, Quebec City (CA)

Correspondence Address: KED & ASSOCIATES, LLP, P.O. Box 221200, Chantilly, VA, 20153-1200, US

(73) Assignee: NORTEL NETWORKS LIMITED, St. Laurent (CA)

(21) Appl. No.: 12/340,998

(22) Filed: Dec. 22, 2008

Related U.S. Application Data
(60) Provisional application No. 61/083,562, filed on Jul. 25, 2008.

(51) Int. Cl. H04J 14/00

(52) U.S. Cl. 398/72; 398/115

(57) ABSTRACT

A system for overlaying an analog broadcast channel in a Wavelength Division Multiplexed Passive Optical Network (WDM-PON). A remote node of the WDM PON includes a MUX/DEMUX for demultiplexing a Wavelength Division Multiplexed (WDM) signal and supplying respective wavelength channels to each one of a plurality of channel fibers; an optical power splitter for supplying the analog broadcast channel to each one of a plurality of distribution paths; and a respective optocoupler connected to each distribution path, each opticoupler coupling the analog broadcast channel into one of the channel fibers. The analog broadcast channel has a wavelength that is outside a wavelength band of the WDM signal. An Optical Network Terminal (ONT), which is connected to one of the channel fibers, includes a triplexer for separating the analog broadcast channel from at least a downlink wavelength channel of the WDM-PON.

### CROSS-REFERENCE TO RELATED APPLICATIONS

This application is based on, and claims priority from, U.S. Provisional Patent Application Ser. No. 61/083,562, filed Jul. 25, 2008, the entire contents of which are incorporated herein by reference.

### FIELD OF THE INVENTION

The present application relates generally to Wavelength Division Multiplexed Passive Optical Networks (WDM PON) and, more specifically, to a method to overlay analog RF/Video broadcast signaling on a WDM-PON network.

### BACKGROUND OF THE INVENTION

A passive optical network (PON) is a point-to-multipoint network architecture in which unpowered optical splitters are used to enable a single optical fibre to serve multiple premises. A PON typically includes an Optical Line Terminal (OLT) at the service provider's central office connected to a number (typically 32-128) of Optical Network Terminals (ONTs), each of which provides an interface to customer equipment.

In operation, downstream signals are broadcast from the OLT to the ONTs on a shared fibre network. Various techniques, such as encryption, can be used to ensure that each ONT can only receive signals that are addressed to it. Upstream signals are transmitted from each ONT to the OLT, using a multiple access protocol, such as time division multiple access (TDMA), to prevent “collisions”.

A Wavelength Division Multiplexing PON, or WDM-PON, is a type of passive optical network in which multiple optical wavelengths are used to increase the upstream and/or downstream bandwidth available to end users. FIG. 1 is a block diagram illustrating a typical WDM-PON system. As may be seen in FIG. 1, the OLT 4 comprises a plurality of transceivers 6, each of which includes a light source 8 and a detector 10 for sending and receiving optical signals on respective wavelength channels, and an optical combiner/splitter 12 for combining light from/to the light source 8 and detector 10 onto a single optical fibre 14. The light source 8 may be a conventional laser diode such as, for example, a distributed feed-back (DFB) laser, for transmitting data on the desired wavelength using either direct laser modulation, or an external modulator (not shown) as desired. The detector 10 may, for example, be a PIN diode for detecting optical signal received through the network. An optical mux/demux 16 (such as, for example, an Arrayed Waveguide Grating—AWG-, or a Thin-Film Filter—TFF) is used to couple light between each transceiver 6 and an optical fibre trunk 18, which may include one or more passive optical power splitters (not shown).

A passive remote node 20 serving one or more customer sites includes an optical mux/demux 22 (which may, for example, also be an AWG or TFF) for demultiplexing wavelength channel (λ1 . . . λn) from the optical trunk fibre 18. Each wavelength channel is then routed to an appropriate PON 24 comprising one or more Optical Network Terminals (ONTs) 26 at respective customer premises. Typically, each ONT 26 includes a light source 28, detector 30 and combiner/splitter 32, all of which are typically configured and operate in a manner mirroring that of the corresponding transceiver 6 in the OLT 4.

Typically, the wavelength channels (λ1 . . . λn) of the WDM-PON are divided into respective channel groups, or bands, each of which is designated for signaling in a given direction. For example, L-band (1570-1612 nm) channels are typically allocated to downlink signals from the OLT 4 to each of the PONs 24, while C-band (1530-1570 nm) channels are allocated to uplink signals transmitted from each PON 24 to the OLT 4.

WDM-PONs suffer a limitation in that they are designed around a one-to-one connection paradigm. That is, each transceiver 6 of the OLT 4 communicates with the ONT(s) 26 of only one PON 24. However, it would be desirable to also be able to broadcast analog signals to all of the ONT(s) 26. For example, it would be desirable to be able broadcast analog RF/video signals to subscribers through the WDM-PON infrastructure. Furthermore, it would be desirable to be able to provide this capability without compromising the performance of the WDM-PON or requiring active components within the network.

### SUMMARY OF THE INVENTION

An aspect of the present invention provides, in a Wavelength Division Multiplexed Passive Optical Network (WDM-PON), a system for overlaying an analog broadcast channel. A remote node of the WDM-PON includes a MUX/DEMUX for demultiplexing a Wavelength Division Multiplexed (WDM) signal and supplying respective wavelength channels to each one of a plurality of channel fibers. An optical power splitter supplies the analog broadcast channel to each one of a plurality of distribution paths. The analog broadcast channel has a wavelength that is outside a wavelength band of the WDM signal. A respective optocoupler is connected to each distribution path. Each opticoupler couples the analog broadcast channel into one of the channel fibers. An Optical Network Terminal (ONT) is connected to one of the channel fibers. The ONT comprises a triplexer for separating the analog broadcast channel from at least a downlink wavelength channel of the WDM-PON.

### BRIEF DESCRIPTION OF THE DRAWINGS

Further features and advantages of the present invention will become apparent from the following detailed description, taken in combination with the appended drawings, in which:

FIGS. 1a and 1b schematically illustrate a conventional WDM-PON known in the prior art;

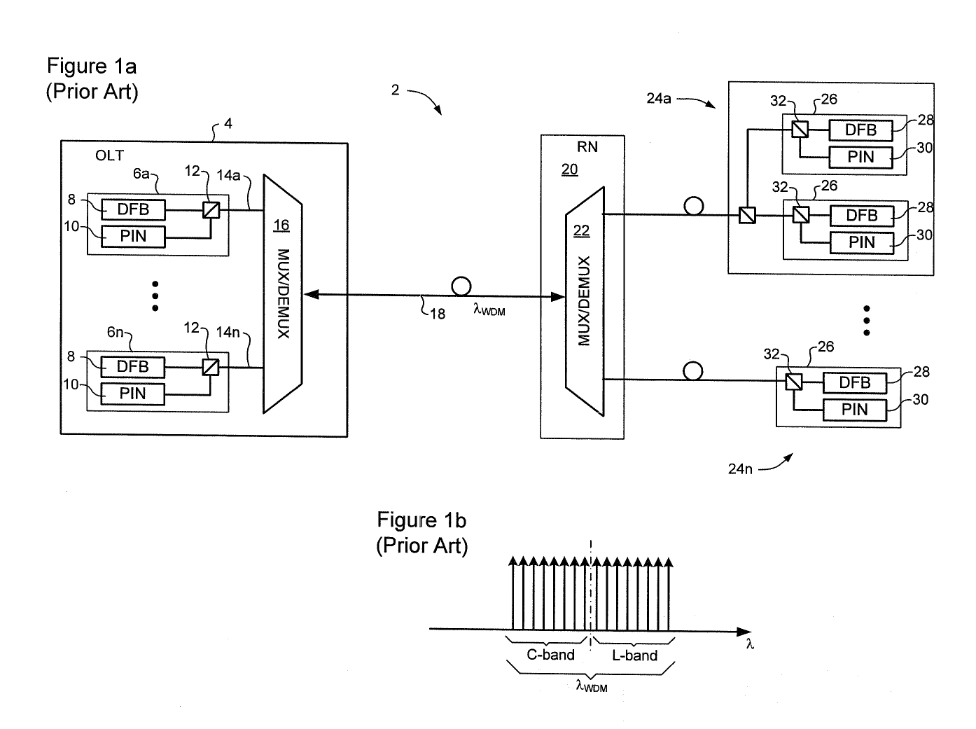

FIGS. 2a and 2b schematically illustrate a WDM-PON in accordance with a first embodiment of the present invention; and

FIG. 3 is a block diagram schematically illustrating a WDM-PON in accordance with a second embodiment of the present invention.

It will be noted that throughout the appended drawings, like features are identified by like reference numerals.

### DETAILED DESCRIPTION OF PREFERRED EMBODIMENTS

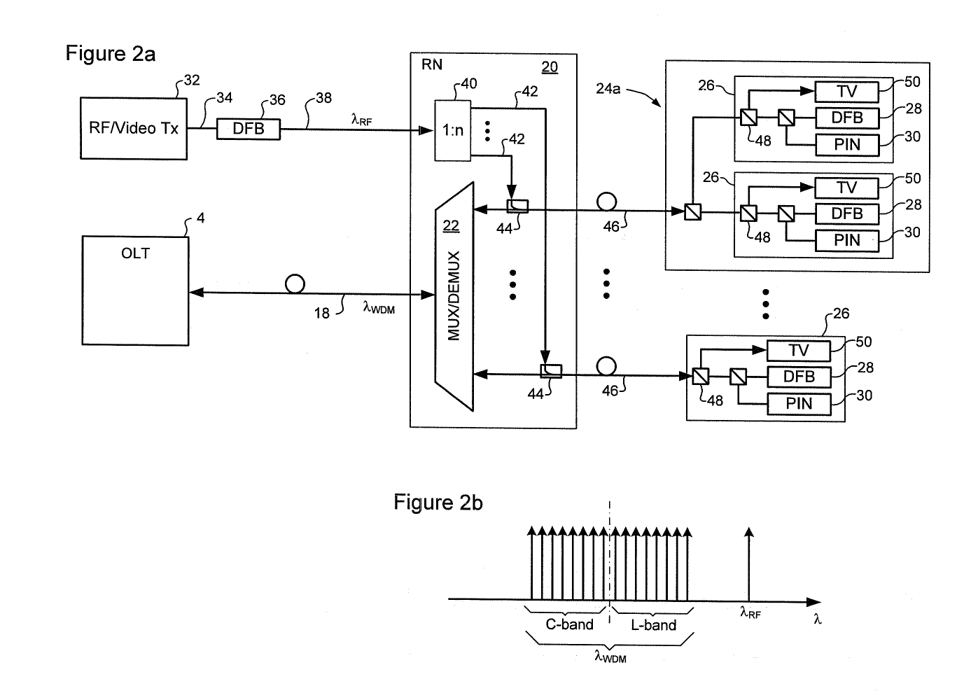

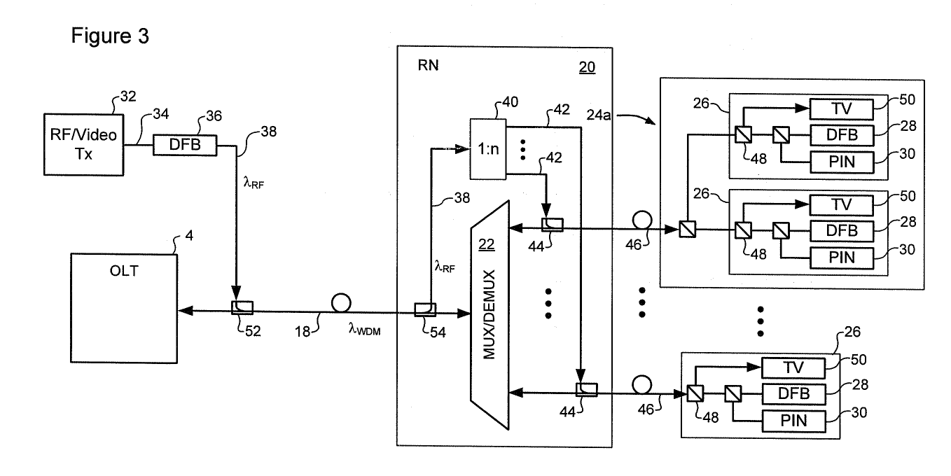

The present invention provides techniques for overlaying RF-Video signaling on a Wavelength Division Multiplexing Passive Optical Network (WDM-PON). Representative embodiments are described below with reference to FIGS. 2 and 3.

In very general terms, in accordance with the present invention, analog RF/Video signals are modulated onto a predetermined wavelength channel λ_{RF} which is selected to lie outside of the digital data wavelength channel band λ1 . . . λn of the WDM-PON. A 1:n power splitter, and directional optocouplers in the remote node 20 enables the RF-Video channel λ_{RF} to be distributed to the ONT(s) 26 at each customer site. A filter-based optocoupler at each ONT 26 can then be used to separate the RF-Video channel λ_{RF} from the inbound light for distribution to the customer's video equipment.

Referring to FIG. 2a, in a first embodiment of the present invention, a conventional RF/Video head-end 32 (which may, for example, be similar to that used in a cable network) is used to generate an RF/Video signal 34 in a conventional manner. An optical transmitter 36 modulates the RF/Video signal 34 onto an optical carrier having a predetermined wavelength (λ_{RF}) to generate a corresponding RF/Video optical signal 38. The optical transmitter 36 may, for example, be provided using a METROLink™ HLD 7105T-Cxx transmitter manufactured by Harmonic Inc. As may be seen in FIG. 2b, the RF/Video channel wavelength λ_{RF} is selected to lie outside the channel bands used for uplink and downlink WDM-PON signaling.

In the embodiment of FIG. 2a, the RF/Video optical signal 38 is conveyed to the remote node 20 using an optical fibre that is separate from that of the fibre trunk 18 of the WDM-PON. Such an arrangement may be useful in networks in which it is undesirable to co-locate the RF/Video head-end 32 with the OLT 4 of the WDM-PON.

Within the remote node 20, a conventional 1:n optical power splitter 40 supplies the RF/Video optical signal 38 to a plurality of distribution paths 42. In some embodiments, the number of distribution paths 42 is equal to the number of output ports of the MUX/DEMUX 22, although this is not essential. As shown in FIG. 2a, each distribution path 42 is connected to an optocoupler 44, which couples the RF/Video optical signal 38 into the channel fiber 46 of a respective PON 24.

Each optocoupler 44 is preferably a unidirectional optical coupler designed to launch the RF/Video optical signal 38 into the channel fiber 46 toward the respective PON 24, while preventing uplink and downlink signals of the WDM-PON from propagating back through the distribution path 42 towards the 1:n power splitter 40. Various known passive optical coupler devices are capable of performing this function. In this respect, the separation between the RF/Video channel wavelength λ_{RF} and the channel bands used for uplink and downlink WDM-PON signals, allows low cost passive filter-based devices to be used for this purpose.

Within each ONT 26, a passive filter-based optocoupler 48 separates the RF/Video optical signal 38 from the channel fiber 46, and supplies the RF/Video optical signal 38 to an RF/Video receiver 50. Optocouplers suitable for use in this embodiment are well known in the art, and thus will not be described in detail herein. As with the optocouplers 44, the separation between the RF/Video channel wavelength λ_{RF} and the channel bands used for uplink and downlink WDM-PON signals, allows low cost passive filter-based devices to be used. The RF/Video receiver 50 operates in a conventional manner to demodulate the RF/Video signal 34 from the RF/Video optical signal 38, and supplies the recovered RF/Video signal 34 (eg via coaxial cable) to a television or “Set Top Box” (not shown).

As may be appreciated, the PON light source 28, detector 30, combiner/splitter 32, filter-based optocoupler 48 and RF/Video receiver 50 can be combined into a triplexer similar to that known for use in EPON/GPON networks. Such an arrangement enables cost savings by using readily available mass-produced components in each ONT 26.

FIG. 3 illustrates an embodiment in which the RF/Video optical signal 38 is transported through the fibre trunk 18 of the WDM-PON. This arrangement is advantageous in cases where the RF/Video head-end 32 can conveniently be co-located with the OLT 4 of the WDM-PON.

The embodiment of FIG. 3 differs from that of FIG. 2 in that a first wide-band optocoupler 52 combines the RF/Video optical signal 38 with the fibre trunk 18 near the output of the OLT 4, and a second wide-band optocoupler 54 extracts the RF/Video optical signal 38 from the fibre trunk 18 and supplies the optical signal 38 to the 1:n power splitter 40. The remaining components of the embodiment of FIG. 3 operate in the same manner as in the embodiment of FIG. 2, and that will not be described in further detail.

As with the optocouplers 44, the wide-band optocouplers 52 and 54 are preferably unidirectional optical couplers designed to couple the RF/Video optical signal 38 into and out of the trunk fiber 18, while imposing minimum losses on the uplink and downlink signals of the WDM-PON being conveyed through the trunk fiber 18 between the OLT 4 and the remote node 20. Various known passive optical coupler devices are capable of performing this function. In this respect, the separation between the RF/Video channel wavelength λ_{RF} and the channel bands used for uplink and downlink WDM-PON signals, allows low cost passive filter-based devices to be used for this purpose.

In the foregoing description, analog RF/Video signals are modulated onto a dedicated wavelength channel λ_{RF} which is selected to lie outside of the digital data wavelength channel band λ1 . . . λn of the WDM-PON. This arrangement is advantageous, in that low cost passive filter-based optocouplers 44, 52 and 54 can be used to couple the analog wavelength channel λ_{RF} into and out of the fibre trunk 18 and channel fibers 46 of the WDM-PON. However, it will be appreciated that, by suitable selection of the bandwidth of the optocouplers 44, 52 and 54, the above-described techniques can equally be used to broadcast analog signals modulated onto two or more analog wavelength channels lying with a predetermined broadcast channel band. As in the case of a single analog wavelength channel λ_{RF}, the broadcast channel band would lie outside the channel bands used by the WDM-PON for digital data traffic.

The embodiments of the invention described above are intended to be illustrative only. The scope of the invention is therefore intended to be limited solely by the scope of the appended claims.

We claim:

1. In a Wavelength Division Multiplexed Passive Optical Network (WDM-PON) including, a system for overlaying an analog broadcast channel, the system comprising:
a remote node comprising:
a MUX/DEMUX for demultiplexing a Wavelength Division Multiplexed (WDM) signal and supplying respective wavelength channels to each one of a plurality of channel fibers;
an optical power splitter for supplying the analog broadcast channel to each one of a plurality of distribution paths; and
a respective optocoupler connected to each distribution path, each opticoupler coupling the analog broadcast channel into one of the channel fibers;
an Optical Network Terminal (ONT) connected to one of the channel fibers, the ONT comprising a triplexer for separating the analog broadcast channel from at least a downlink wavelength channel of the WDM-PON;
wherein the analog broadcast channel has a wavelength that is outside a wavelength band of the WDM signal.

2. The system as claimed in claim 1, wherein the analog broadcast channel is supplied to the optical power splitter via an optical signal path that is independent of the WDM-PON.

3. The system as claimed in claim 1, wherein the analog broadcast channel is supplied to the optical power splitter via a trunk fibre carrying the WDM signal of the WDM-PON, and wherein the system further comprises:
a first WDM optocoupler for coupling the analog broadcast channel into the trunk fibre, the first WDM optocoupler being connected to the trunk fibre near an Optical Line Terminal (OLT) of the WDM-PON; and
a second WDM optocoupler connected to the trunk fibre at the remote node, the second WDM optocoupler separating the analog broadcast channel from the trunk fibre and supplying the analog broadcast channel to an input port of the optical power splitter.
